(19) United States
(12) Patent Application Publication
(10) Pub. No.: US 2020/0027475 A1
(43) Pub. Date: Jan. 23, 2020

(54) SYSTEM AND METHOD FOR THREAT DETECTION, CLASSIFICATION, WARNING AND ALERTING OF MOBILE USERS

(71) Applicant: Maya Balan, Highlands Ranch, CO (US)

(72) Inventor: Maya Balan, Highlands Ranch, CO (US)

(21) Appl. No.: 16/041,749

(22) Filed: Jul. 21, 2018

(51) Int. Cl. G10L 25/63; G08B 21/02; G10L 25/93

(52) U.S. Cl. CPC G10L 25/63; G10L 2025/932; G10L 25/93; G08B 21/02

(57) ABSTRACT

Embodiments of the invention are designed to detect a threat (such as an imminent automobile collision), and generates a audible warning to override the media distraction of a disengaged user. The user may take evasive action and acknowledge the warning, at which point the system resets and retreats to it vigilance mode. On the other hand, a system initiated alert is generated as a compensatory follow up step to a user who is non-responsive (does not acknowledge a system identified warning), and in such cases the system will transmit a user safety alert comprising the warning data and geolocation parameters, to first responders and interested parties such that they may engage the user to determine their current situation, or preemptively act to remedy a life threatening situation.

In the case of a user initiated alert, a user who might sense the threat of physical violence will trigger the generation of an alert via a customizable distress phrase causing the vigilance system to assemble and transmit an alert in real-time with the user's geolocation, live audio and video data information in the alert payload.

### RELATED APPLICATIONS

The present application is related to United States patent number US20080240458A1, issued Apr. 3, 2012, included by reference herein.

The present application is related to United States patent number U.S. Pat. No. 8,249,547B1, issued Aug. 21, 2012, included by reference herein.

The present application is related to United States patent number U.S. Pat. No. 9,451,061B2, issued Sep. 20, 2016, included by reference herein.

The present application is related to United States patent number U.S. Pat. No. 7,617,287B2, issued Nov. 10, 2009, included by reference herein.

### FIELD OF THE INVENTION

Embodiments relate generally to mobile phone applications which function as user safety and alerting systems. The embodiments function as vigilance agents listening for potential threats to warn mobile users about, and alert interested parties.

### BACKGROUND OF THE INVENTION

Numerous accidents stem from people who are fully or partially unaware of their surroundings while distracted by media, specifically from mobile devices. One component of the distraction is loud music on devices that is frequently listened to on earbuds or headphones while people are outside exercising or simply walking on the street. Although listening to music is a common practice in everyday society, it can lead to several accidents specifically on city streets. For example, a pedestrian in the process of crossing a street may not hear or notice an oncoming vehicle, as the music on their headphones might interfere with their ability to detect external sounds, a situation which may potentially put them in harm's way.

Mobile emergency alerting devices have been used for some time to provide a degree of security and safety to users, especially in the event of accidents and bodily harm. Examples of such emergency devices are the “Life Alert” device manufactured by life Alert Emergency Response, Inc., and the American Medical device that is distributed by American Medical Alarms, Inc. In most cases, a user initiated signal (such as pressing a designated button on the device) will connect the user to the help Desk or call center, where the nature of the emergency (and subsequent remedial action) is determined in a conversation with the user. The limitations of such systems lie in the fact that they cannot accurately convey the nature of the emergency (location/details) without extensive user interaction. Additionally, the initial interaction with the help desk cannot commence without a user initiated gesture, such as a button press or a phone conversation. Finally, while these systems do have a mobile presence, they are primarily residence-centric and address the emergencies which arise around the residence.

The invention described here addresses some of these shortcomings, namely it allows for the dynamic classification, warning and automated transmission of warnings and threats for a user on the go in urban, suburban and rural communities.

The pertinent aspects of the invention are:

The user warning feature will aid in the identification and warning of hazards a user may encounter in a mobile lifestyle, such as automobile accident threats a pedestrian might encounter while walking or jogging in an urban setting while distracted by media on a mobile phone.

The alerting feature of the invention, will attempt to alert first responders of potential harm to a user via a custom notification (sms/email). This is accomplished by transmitting a customizable alert payload comprising of the user initiated or system determined safety events along with dynamically recorded audio/video data in conjunction with real-time geolocation data to accurately describe the location and nature of the threat.

### SUMMARY OF THE INVENTION

Embodiments of the invention are designed to detect a threat (such as an imminent automobile collision), and generates an audible warning to override the media distraction of a disengaged user. The user may take evasive action and acknowledge the warning, at which point the system resets and retreats to it vigilance mode. On the other hand, a system initiated alert is generated as a compensatory follow up step to a user who is non-responsive (does not acknowledge a system identified warning), and in such cases the system will transmit a user safety alert comprising the warning data and geolocation parameters, to first responders and interested parties such that they may engage the user to determine their current situation, or preemptively act to remedy a life threatening situation.

In the case of a user initiated alert, a user who might sense the threat of physical violence will trigger the generation of an alert via a customizable distress phrase causing the vigilance system to assemble and transmit an alert in real-time with the user's geolocation, live audio and video data information in the alert payload.

It would be advantageous to provide a warning system for mobile users on the go.

It would also be advantageous to provide an alerting system to first responders and interested parties in the event of an unaticipated threat or unackowledged warning message.

It would further be advantageous to provide a configurable system of threats, such that users may configure and customize the warning system to their specific needs.

It would further be advantageous to provide a configurable system of alerts, such that users may configure and customize the alerting system to contain specific data corresponding to their threat situation.

It would further be advantageous to provide a configurable system of alert delivery, such that users may configure and customize the alert delivery to specific recipients over specific channels.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front detail view of a configuration flow as contained in the warning system for an embodiment;

FIG. 2 is a front detail view of a configuration flow as contained in the alerting system for an embodiment;

FIG. 3 is a front view of an embodiment of the mobile application configuration screens;

FIG. 4 is a front view of an illustration of the warning flow of an embodiment; and

FIG. 5 is a front view of an illustration of the alerting flow of an embodiment.

For purposes of clarity and brevity, like elements and components will bear the same designations and numbering throughout the Figures.

### DESCRIPTION OF THE PREFERRED EMBODIMENT

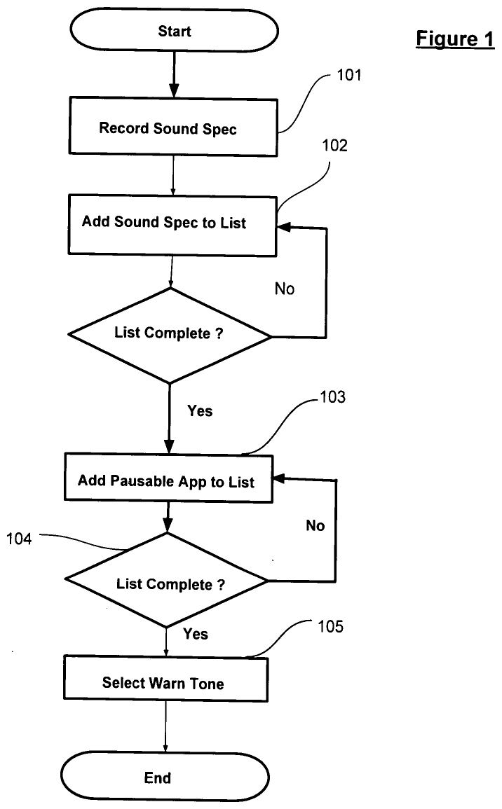

FIG. 1 is an illustration of the configuration of the warning submodule for an embodiment.

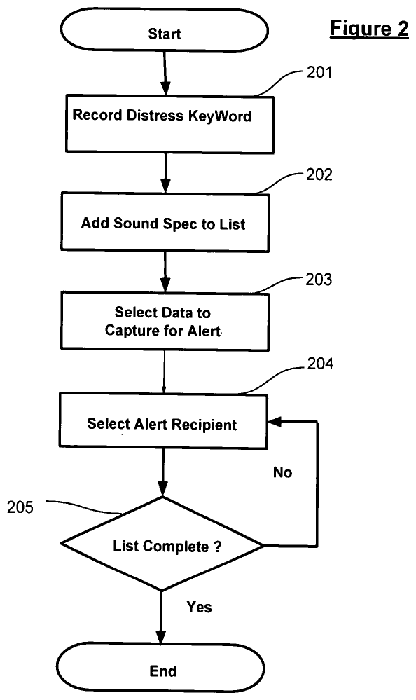

FIG. 2 is an illustration of the configuration of the alerting submodule for an embodiment.

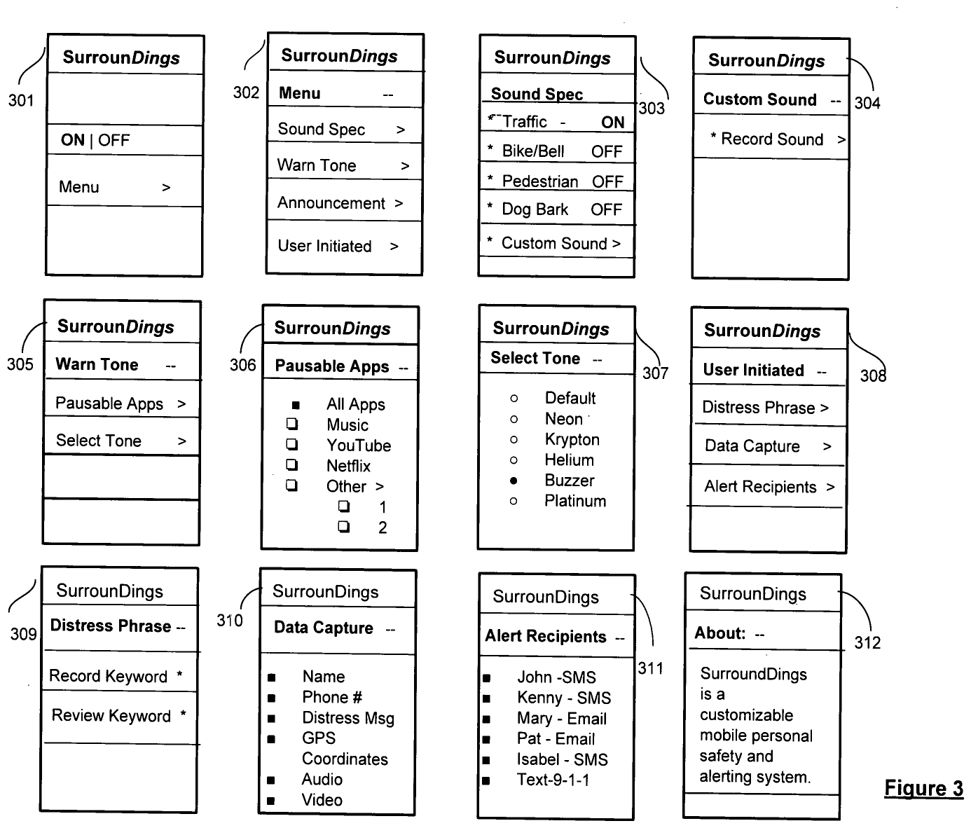

FIG. 3 is an illustration of the mobile application configuration screens of an embodiment.

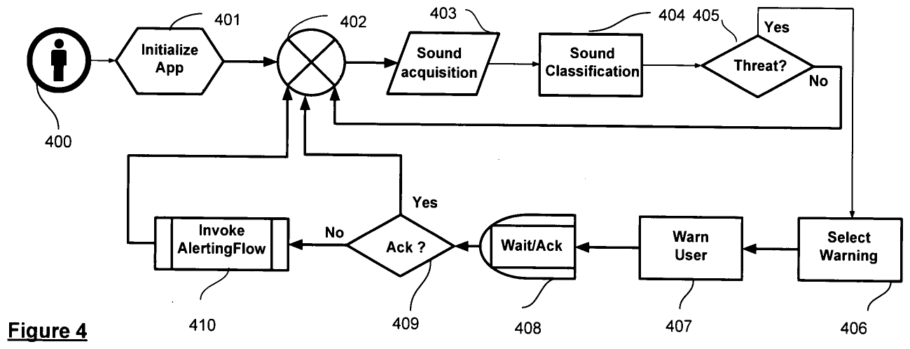

FIG. 4 is an illustration of the warning flow of an embodiment.

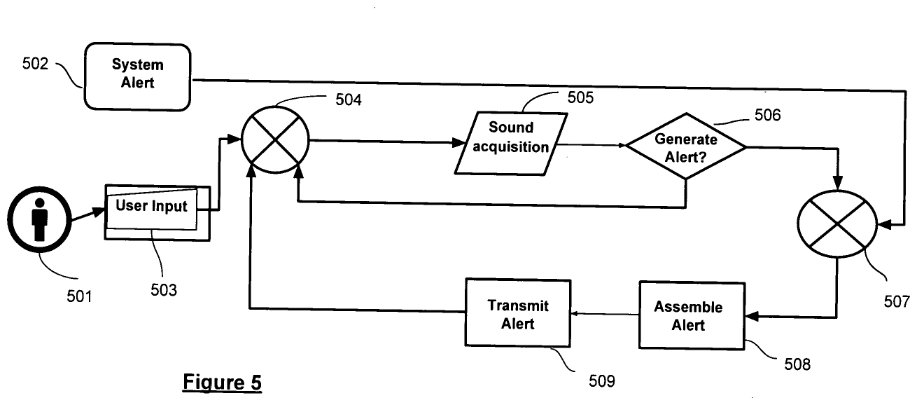

FIG. 5 is an illustration of the alerting flow of an embodiment.

In the following description of various illustrative embodiments, reference is made to the accompanying drawings, which form a part hereof, and in which is shown, by way of illustration, various embodiments in which aspects of the disclosure may be practiced. It is to be understood that other embodiments of the application and or submodules may be designed and or utilized, and structural and functional modifications may be made, without departing from the scope of the present disclosure.

As discussed above, various aspects of the disclosure relate to warning users of the mobile application from traffic related threats, as well as alerting interested parties of potential or imminent harm to the user, in the event the user is deemed to require assistance.

FIG. 1 illustrates the typical steps a user would undertake to configure a sample embodiment of the mobile application derived from this invention to prepare the embodiment for the warning capability of the invention. Step 101 would be the initial processing step where the user will decide or a supplied traffic sound (example oncoming truck sound) to be included as a sound to monitor as a threat. Step 102 would iteratively apply sound processing filters to normalize the sound with respect to other pre-existing sounds if any in the list of sounds to warn against. The sample embodiment of Step 103 would examine the list of installed applications on the device and prompt the user to select and verify the applications the sample embodiment would override (pause and mute) and announce threats over. The sample embodiment would perform this step iteratively or as desired by the user to complete the list of overridable applications, as shown in step 104. Step 105 would be the final step in the warning submodule configuration where a warning tone may be optionally selected in lieu of the default warning tone configured into the embodiment.

The typical steps a user would undertake to configure an embodiment of the invention to prepare the embodiment for the alerting capability of the invention is illustrated in FIG. 2. The embodiment in step 201 records and normalizes a user uttering of a distress keyword. Step 202 adds the distress keyword to a list of distress keywords. Step 203 prompts the user to select the data to be captured as pertinent to the alert message. For example, the sample embodiment allows the user to select the geo-location of the user, and some generated audio and video data to provide context to the nature of the threat encountered by the user. Step 204 in the sample embodiment allows the user to select a list of interested parties as recipients and allows for the configuration of method of communicating the alert to each interested party. For example, the embodiment may offer the user the choice of configuring SMS or Email as the vehicles of transporting the alert.

FIG. 3 illustrates the configuration screens of a sample embodiment as envisioned by the inventors. The Main screen 301 allows for the app to be toggled off or on as needed and provides top level access to a configuration menu 302 which further allows the user to navigate to following sub-menus 303 to configure common sounds to warn for, and menu items 304 and 305 to record a custom sound the warning submodule will listen for. The sample embodiment of sub-menu item 306 allows the user to select the applications the warning submodule will be able to pause and mute to announce a detected warning. In the sample embodiment sub-menu 307 allows for the selection of a warning tone playable when the actual warning needs to be emitted. Menu item 308 in the sample embodiment illustrates the main entry point for configuration of the alerting submodule. Menu item 309 demonstrates a sample embodiment of configuring a distress phrase for user initiated alerting as illustrated in FIG. 2 step 201. Menu item 310 illustrates the data capture parameters which may be configured from a list of choices to provide information about what data would be transmittable in an alert message. Sub-menu item 311 would prompt the user to select a list of interested parties for the alert along with the method of communication for each alert recipient.

The setup and operation of the warning submodule once configured is illustrated in FIG. 4. A user 400 would initialize the submodule within the application to vigilance mode 402, which would activate the submodule to listen and acquire ambient sounds as illustrated in step 403. Once a sound above the warning threshold is encountered as illustrated in step 403, it is matched against the preconfigured list of warning sounds as illustrated by step 404. A determination of whether the sound is a threat or random noise is made in step 405 by matching the encountered sound to the preconfigured list of warning sounds. If the sound is deemed to not be a threat, the acquired sound is discarded and the system resets to the vigilance mode 402. In the event that the sound encountered is deemed to be a threat in step 405, the warning tone configured in step 105 is selected and the user is warned via the continuous playing of the warning tone over the speakers or connected headset of the mobile device in step 407. The user is also presented a count-down timer and a method of acknowledging the generated alert. For example, an embodiment of this feature may start a 10 second timer and expect the user to press a control on the mobile device to register acknowledgement as illustrated in step 408. The system will wait for the preconfigured amount of time and if an acknowledgement is received, the system may infer that the user had successfully completed maneuvers to avoid the threat inferred by the warning. The system will then reset to vigilance mode 402 to listen for the next potential threat. In the event the user does not acknowledge the issued warning by the warning submodule in the preconfigured time span, the alerting flow described in FIG. 5 will be triggered with a starting point of step 502, a system alert 16.

The operation of the alerting flow is illustrated in FIG. 5. An alerting flow may be initiated in one of two ways, either by a system generated alert (FIG. 4, step 401), or via an explicit user triggered alert. In the event of a system alert 16 it is assumed that the preconditions for alerting have been met and the alerting submodule will assemble the configured data for the alert (configured in FIG. 2, step 203), as illustrated in step 508. Once assembled the alert will be generated and transmitted to the interested parties (as finalized in FIG. 2, step 205) in step 509. In the case of a user specified alert the system will listen for a distress keyword as illustrated in step 505. If the acquired sound matches with a configured distress keyword sound as configured in FIG. 2 steps 201 and 202, the system will proceed to trigger the assembly of an alert message as illustrated in step 508 (with alert data as configured in FIG. 2, step 203). Once assembled the alert will be generated and transmitted to the interested parties in step 509 (as finalized in FIG. 2, step 205).

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A system and method for threat detection, classification, warning and alerting of mobile users, comprising:
means for classification of encountered sounds by the warning system as threats or as unrelated noise;
means for warning the user of detected threats;
means for recording and storing potential distress signals such that they may serve to help classify utterances by the user into either distress phrases or ambient noise;
means for generating automatic alerts as compensation for lack of user expected input upon receiving a warning;
means for generating an alert message designated to be transmitted to interested parties when a alert distress phrase is recognized; and
means for the delivery of system generated or user initiated alerts messages to configured interested parties.

2. The system and method for threat detection, classification, warning and alerting of mobile users in accordance with claim 1, wherein said means for classification of encountered sounds by the warning system as threats or as unrelated noise comprises a warming classification system.

3. The system and method for threat detection, classification, warning and alerting of mobile users in accordance with claim 1, wherein said means for warning the user of detected threats comprises a warning system.

4. The system and method for threat detection, classification, warning and alerting of mobile users in accordance with claim 1, wherein said means for recording and storing potential distress signals such that they may serve to help classify utterances by the user into either distress phrases or ambient noise comprises an alert distress phrase system.

5. The system and method for threat detection, classification, warning and alerting of mobile users in accordance with claim 1, wherein said means for generating automatic alerts as compensation for lack of user expected input upon receiving a warning comprises a system alert.

6. The system and method for threat detection, classification, warning and alerting of mobile users in accordance with claim 1, wherein said means for generating an alert message designated to be transmitted to interested parties when a alert distress phrase is recognized comprises an user initiated alert.

7. The system and method for threat detection, classification, warning and alerting of mobile users in accordance with claim 1, wherein said means for the delivery of system generated or user initiated alerts messages to configured interested parties comprises an alerting system.
